(19) United States
(12) Patent Application Publication
(10) Pub. No.: US 2007/0022665 A1
(43) Pub. Date: Feb. 1, 2007

(54) Assembly for holding a window pane of a window lifter

(75) Inventors: Jean-Francois Bigourden, Neudorf-Platendorf (DE); Markus Waroch, Isenbuettel (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/491,863

(22) Filed: Jul. 24, 2006

(30) Foreign Application Priority Data
Jul. 27, 2005 (DE) 10 2005 035 197.2

(51) Int. Cl. E05F 11/38

(52) U.S. Cl. 49/375

(57) ABSTRACT

An assembly for holding a window pane of a window lifter includes a base body with at least one elongated hole having a shape of a circular arc. The assembly also includes a clamping jaw that is attached to the base body, and which has a guide that engages the elongated hole.

### RELATED APPLICATIONS

The application claims priority to German Application No. 10 2005 035 197.2, which was filed on Jul. 27, 2005.

### BACKGROUND OF THE INVENTION

The invention relates to a holding assembly for holding a window pane of a window lifter.

The holding assembly is a well-known component in conventional cable pull type window lifters which are employed in motor vehicles. These window lifters usually have two rails which, for instance, are installed in a vehicle door, with one holding assembly being attached to each rail. The holding assembly can be realized as a carriage, or a holding plate of the holding assembly may be part of the carriage. A lower edge of a window pane is clamped in the two holding assemblies, such that the window pane can be shifted in the vehicle door.

Disadvantageously, the holding assembly usually has four different configurations that are stocked. One configuration is for the front rail on a first vehicle side, one configuration is for a front rail on a second vehicle side, one configuration is for a rear rail on the first vehicle side, and the final configuration is for a rear rail on the second vehicle side. It is the object of the invention to provide a holding assembly for holding a window pane for a window lifter to the effect that only one configuration of the holding assembly is required, which can be used in any installation situation.

### SUMMARY OF THE INVENTION

The subject invention provides a single holding assembly for holding a window pane of a window lifter that can be used for all installation positions. The holding assembly includes a base body provided with at least one elongated hole having a shape of a circular arc, and a clamping jaw that is attached to the base body and has a guide engaging the elongated hole. The guide, which is arranged on the clamping jaw or is a part thereof, can move within the elongated hole, so that the clamping jaw can be attached to the base body with different inclinations. Even slight modifications of the inclination can be provided, because the elongated hole has the shape of a circular arc. This results in a cost reduction for the window lifter because multiple configurations of the holding assemblies are no longer required to be stocked. Instead, only one single configuration is needed for all installation positions.

The guide preferably is a pin that is formed in one piece with the clamping jaw. This one-piece design of the pin ensures that there is a stable unit of clamping jaw and guide, in particular as the clamping jaw is a bent sheet metal part.

It is preferred that a stopper disc has a round contact surface with which the window pane can come into contact. Due to the round contact surface, the window pane can rest at an outer surface of the stopper disc in any direction, because spacing of a fastening bolt, on which the stopper disc is arranged, to an edge of the window pane is constant.

A clamping rubber piece, for instance, is arranged between the base body and the clamping jaw. The clamping rubber piece prevents a direct contact between the base body of sheet metal or the clamping jaw and the window pane. Any direct contact could result in a local overload of the window pane and cause destruction.

The clamping rubber piece preferably has a U-shaped cross-section with two legs. One leg is in flat contact with the base body, and the other leg is fastened to the clamping jaw.

The leg of the clamping rubber piece that is fastened to the clamping jaw is preferably provided with a hook-like edge portion, so that the clamping rubber piece is fixed on the clamping jaw.

According to one example of a preferred embodiment, the base body has two elongated holes that are opposite each other, with a center of curvature of these two elongated holes coinciding with an axis of fixation of the clamping jaw on the base body. Spacing between the guide and a point at which the clamping jaw is fastened to the base body with the fastening bolt, remains always the same. As the center of curvature of the elongated holes coincides with the axis of the fixation of the clamping jaw on the base body, the clamping jaw can be fastened to the holding assembly in a state of having been rotated by 180°, so that the holding assembly can, for instance, be used both on a front rail on one vehicle side and on the front rail on an opposite vehicle side. This results in a cost reduction of the window lifter.

The holding assembly may be a carriage, with the holding assembly itself having a sliding portion that can be moved in a rail of the window lifter. As an alternative, the holding assembly may be fastened to an intermediate part, with this intermediate part itself having a sliding portion that is movable in the rail of the window lifter.

These and other features of the present invention can be best understood from the following specification and drawings, the following of which is a brief description.

### BRIEF DESCRIPTION OF THE DRAWINGS

FIG. 1 shows an exploded view of an assembly for holding a window pane of a window lifter according to the invention.

FIG. 2 shows a perspective side view of an assembled holding assembly from one side.

FIG. 3 shows a further perspective side view of the assembled holding assembly as seen from an opposite side according to FIG. 2.

FIG. 4 shows a perspective view of a clamping rubber piece of the holding assembly according to the invention.

FIG. 5 is a schematic view of a clamping jaw in two positions.

### DETAILED DESCRIPTION OF THE PREFERRED EMBODIMENT

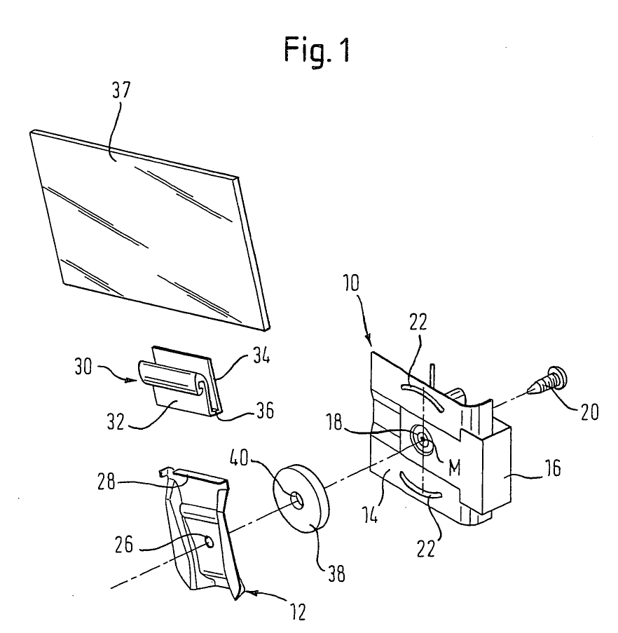

In FIGS. 1, 2 and 3, an assembly for holding a window pane of a window lifter is shown. The essential components of the assembly are a base body 10 and a clamping jaw 12. Both the base body 10 and clamping jaw 12 are stamped and bent sheet metal parts.

The base body 10 has a body portion 14 and a sliding portion 16. The sliding portion 16 is provided for being movably attached in a rail of a window lifter. Sliding pieces (not shown) are usually inserted in the sliding portion 16, which are made of plastic and serve for guiding the base body 10 on the rail with low friction and noise.

In an embodiment which is not shown, the holding assembly could be fastened alternatively to an intermediate part that includes the sliding portion 16, and which can be moved in the rail of the window lifter, instead of the holding assembly (as is shown) itself comprising the sliding portion 16, and hence being a carriage of the window lifter.

The base body 10 is provided with a hole 18 that has a thread, and which serves for receiving a fastening bolt 20. The base body 10 has two elongated holes 22 in the shape of a circular arc, which are opposite each other and have a center of curvature M that coincides with an axis of the fixation of the clamping jaw 12 on the base body 10 with the fastening bolt 20 (see FIG. 1). Here, the elongated holes 22 are punched holes with a width chosen such that a guide 24 (FIG. 3) of the clamping jaw 12 can engage the respective elongated hole 22.

The clamping jaw 12 has the aforementioned guide 24 at a lower edge with respect to FIG. 1. The guide 24 (see in particular FIG. 3) is formed in one piece with the clamping jaw 12 and has the shape of a pin, so that the guide 24 protrudes from the body portion 14 after having penetrated the elongated hole 22.

A punched hole 26, through which the fastening bolt 20 can be inserted, is provided on the clamping jaw 12.

At an upper edge, the clamping jaw 12 is provided with a barb 28 configured as an embossment. A rim that is bent out of a plane of the clamping jaw 12 points at the punched hole 26.

A U-shaped clamping rubber piece 30 is provided that has first 32 and second 34 legs. The first leg 32 has a hook-like edge portion (FIG. 4). The hook-like edge portion cooperates with the barb 28 on the clamping jaw 12, so that the clamping rubber piece 30 is reliably retained on the clamping jaw 12.

The second leg 34 of the clamping rubber piece 30, however, is configured to have a flat shape and rests at the base body 10 in the installed condition. The base body 10 likewise is planar in a region where the second leg 34, i.e., the flat leg of the clamping rubber piece 30 can rest at, so that the clamping rubber piece 30 is not hindered by a protrusion or the like to perform a rotation.

Between the first and second legs 32, 34, the clamping rubber piece 30 has a flat bottom 36 at which a window pane 37 rests in an assembled condition.

A stopper disc 38 with a round outer surface has a central opening 40 through which the fastening bolt 20 is inserted. In the assembled state, the stopper disc 38 is arranged between the base body 10 and the clamping jaw 12, with the clamping rubber piece 30 abutting at an outer surface of the stopper disc 38.

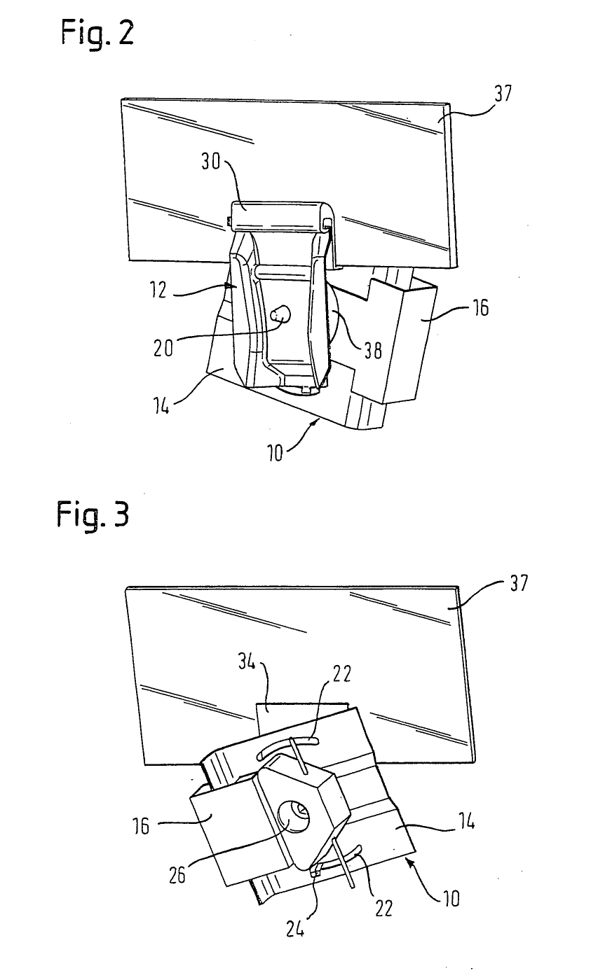

FIGS. 2 and 3 show the holding assembly in the assembled state. The hook-like edge portion of the clamping rubber piece 30 is fastened to the barb 28 of the clamping jaw 12, and the guide 24 of the clamping jaw 12 is forced through the elongated hole 22 in the base body 10. To attach the fastening bolt 20, the fastening bolt 20 is inserted through the hole 18 in the base body 10, then through the opening 40 of the stopper disc 38, and next through the punched hole 26 of the clamping jaw 12. The window pane 37 is introduced in the gap between the first and second legs 32, 34 of the clamping rubber piece 30, so that a lower edge of the window pane 37 rests at the flat bottom 36 of the clamping rubber piece 30. The flat bottom 36 of the clamping rubber piece 30 rests at the stopper disc 38, and the clamping rubber piece 30 aligns by its own due to the round outer surface of the stopper disc 38.

The clamping jaw 12 can be attached to the base body 10 with any inclination, because the guide 24 can be arranged in the elongated hole 22 having the shape of a circular arc with different orientations. Moreover, the flat bottom 36 of the clamping rubber piece 30 can abut at the round outer surface of the stopper disc 38 in many different positions.

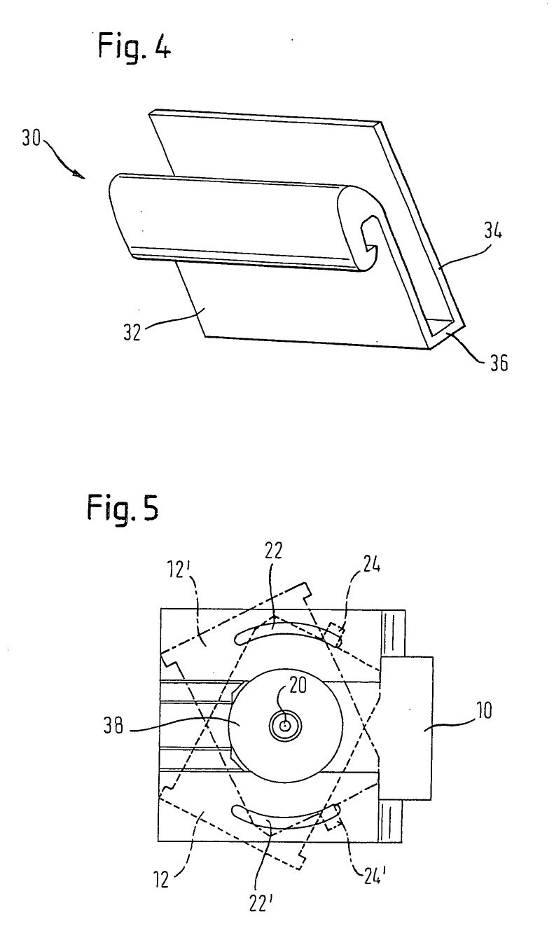

FIG. 5 shows that the clamping jaw 12 can be attached both to a lower elongated hole 22′ (according to FIG. 5) of the base body 10 and—rotated by 180°—to an upper elongated hole 22 of the base body 10, so that the same holding assembly can be attached to front and rear rails on both sides of the vehicle.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An assembly for holding a window pane of a window lifter, comprising:
a base body provided with at least one elongated hole having a shape of a circular arc; and
a clamping jaw that is attached to the base body and has a guide engaging the at least one elongated hole.

2. The assembly according to claim 1, wherein the guide is a pin that is formed in one piece with the clamping jaw.

3. The assembly according to claim 1, including a fastening bolt that attaches the clamping jaw to the base body, and a stopper disc that is arranged on the fastening bolt and acts as a stop for a window pane clamped between the base body and the clamping jaw.

4. The assembly according to claim 3, wherein the stopper disc has a round outer surface that contacts the window pane.

5. The assembly according to claim 1, including a clamping rubber piece provided between the base body and the clamping jaw.

6. The assembly according to claim 5, wherein the clamping rubber piece has a U-shaped cross-section with first and second legs, with the first leg being in flat contact with the base body and the second leg being attached to the clamping jaw.

7. The assembly according to claim 6, wherein the second leg is provided with a hook-like edge portion.

8. The assembly according to claim 6, wherein the clamping rubber piece includes a flat bottom between the first and second legs.

9. The assembly according to claim 1, wherein the at least one elongated hole comprises two elongated holes that are opposite each other, with a center of curvature of the two elongated holes coinciding with an axis of fixation of the clamping jaw on the base body.

10. The assembly according to claim 1, wherein the assembly is a carriage of a window lifter system.
